(19) United States
(12) Patent Application Publication
(10) Pub. No.: US 2026/0022043 A1
(43) Pub. Date: Jan. 22, 2026

(54) WASTEWATER DIFFUSER WITH INTEGRATED CLEANING MECHANISM

(71) Applicant: SSI Aeration Inc., Poughkeepsie, NY (US)

(72) Inventors: Thomas E. Frankel, Poughkeepsie, NY (US); Seoungil Kang, Poughkeepsie, NY (US); Todd D. Ritter, Poughkeepsie, NY (US)

(21) Appl. No.: 18/776,331

(22) Filed: Jul. 18, 2024

(51) Int. Cl. C02F 1/74

(52) U.S. Cl. CPC C02F 1/74; C02F 2201/002; C02F 2303/20

(57) ABSTRACT

A system includes an air distribution pipe and a diffuser attached to the pipe. The diffuser includes a diffuser body, a flexible diffuser membrane, a cage, and a cleaning element. The flexible diffuser membrane and the cage are attached to the diffuser body. The cleaning element is trapped between the flexible diffuser membrane and the cage. With the system immersed in wastewater, providing pressurized air to the diffuser causes the flexible diffuser membrane to release a plume of bubbles into the wastewater. The plume of bubbles agitates the cleaning element causing repeated impacts between the cleaning element and the flexible diffuser membrane. The repeated impacts between the cleaning element and the flexible diffuser membrane clean the flexible diffuser membrane.

### FIELD OF THE INVENTION

The present invention relates generally to wastewater treatment, and, more particularly, to diffusers for use in treating wastewater.

### BACKGROUND OF THE INVENTION

Diffusers are conventionally used to support aerobic biological processes in wastewater treatment plants. A disc-type diffuser typically comprises a flexible diffuser membrane that is constructed of rubber or other similar materials and is perforated with holes or slits. In operation, pressurized air is sent through these perforations to create a plume of small bubbles. The bubbles rise through the wastewater and provide the wastewater with the oxygen needed to sustain desired biological processes.

Although flexible diffuser membranes are advantageous in many respects and have achieved widespread acceptance, they are not wholly free of problems. In a wastewater treatment application, materials in the wastewater can become deposited on and build up on the flexible diffuser membrane to clog or partially clog the perforations. For example, fats, greases, and other organic substances which are commonly found in wastewater can adhere to the flexible diffuser membrane causing fouling. Calcium and calcium compounds such as calcium carbonate and calcium sulfate as well as other inorganic substances are especially problematic when they precipitate and build up on the flexible diffuser membrane causing scaling. These inorganic substances may also bind sand, grit, and organic deposits. Such membrane contamination reduces the efficiency of the aeration system by requiring that the air source work harder to overcome the added flow resistance (i.e., head loss) at the membrane-wastewater interface. In addition, efficiency is further impacted because the bubbles typically become larger, and the plumes of bubbles become less spatially uniform. Ultimately, when membrane contamination becomes severe enough, a wastewater treatment tank must be shut down so that its diffusers can be cleaned or replaced.

For the foregoing reasons, there is a need for diffusers that are cleaned continuously and in situ, thereby increasing aeration efficiency and the interval between maintenance.

### SUMMARY OF THE INVENTION

Embodiments of the present invention address the above-identified need by providing a diffuser with self-cleaning capabilities, the cleaning occurring continuously and in situ while the diffuser is operating.

Aspects of the invention are directed to a diffuser comprising a diffuser body, a flexible diffuser membrane, a cage, and a cleaning element. The flexible diffuser membrane and the cage are attached to the diffuser body. The cleaning element is trapped between the flexible diffuser membrane and the cage.

Additional aspects of the invention are directed to a system comprising an air distribution pipe and a diffuser attached to the pipe and in gaseous communication with an interior of the air distribution pipe. The diffuser comprises a diffuser body, a flexible diffuser membrane, a cage, and a cleaning element. The flexible diffuser membrane and the cage are attached to the diffuser body. The cleaning element is trapped between the flexible diffuser membrane and the cage. The diffuser is immersed in wastewater. Providing pressurized air to the diffuser causes the flexible diffuser membrane to release a plume of bubbles into the wastewater. The plume of bubbles agitates the cleaning element causing repeated impacts between the cleaning element and the flexible diffuser membrane. The repeated impacts between the cleaning element and the flexible diffuser membrane clean the flexible diffuser membrane.

Advantageously, diffusers in accordance with aspects of the invention maintain a lower flow resistance, a smaller bubble size, and a more spatially uniform bubble pattern for a longer period than would be experienced with a conventional diffuser in like conditions. Aeration efficiency and the interval between expensive and disruptive maintenance are thereby increased when compared to prior designs.

### BRIEF DESCRIPTION OF THE DRAWINGS

These and other features, aspects, and advantages of the present invention will become better understood with regard to the following description and accompanying drawings where:

FIG. 1 shows a partially broken perspective view of a diffuser in accordance with an illustrative embodiment of the invention;

FIG. 2 shows an exploded partially broken perspective view of the FIG. 1 diffuser and air distribution pipe;

FIG. 3 shows a magnified perspective view of the FIG. 1 diffuser in the region indicated in FIG. 1.

FIGS. 4 and 5 show sectional views along the cleave plane indicated in FIG. 3 during and after snap-fit attachment of the FIG. 1 cage to the FIG. 1 diffuser body;

FIG. 6 shows a side view of a representative one of the FIG. 1 cleaning elements;

FIG. 7 shows a partially broken side view of the FIG. 1 diffuser and air distribution pipe during operation;

FIG. 8 shows a magnified side view of the region of the FIG. 1 diffuser indicated in FIG. 7;

FIG. 9 shows a partially broken perspective view of the first alternative diffuser;

FIG. 10 shows a magnified perspective view of a portion of a second alternative diffuser;

FIG. 11 shows an exploded magnified perspective view of a portion of a third alternative diffuser;

FIG. 12 shows a perspective view of a first alternative cleaning element; and

FIG. 13 shows a perspective view of a second alternative cleaning element.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

As used herein and in the appended claims, a “diffuser” is an aeration device for treating wastewater. A “disc diffuser” is a diffuser with a mostly flat, circular flexible diffuser membrane. “Directly” means without an additional element in between. An element is “integral” to another element if the two elements cannot be separated without cutting, breaking, melting, or otherwise damaging one or both elements. “Snap-fit attachment” means attachment by pushing interlocking components together and without use of adhesives or separate mechanical fasteners (e.g., screws or bolts).

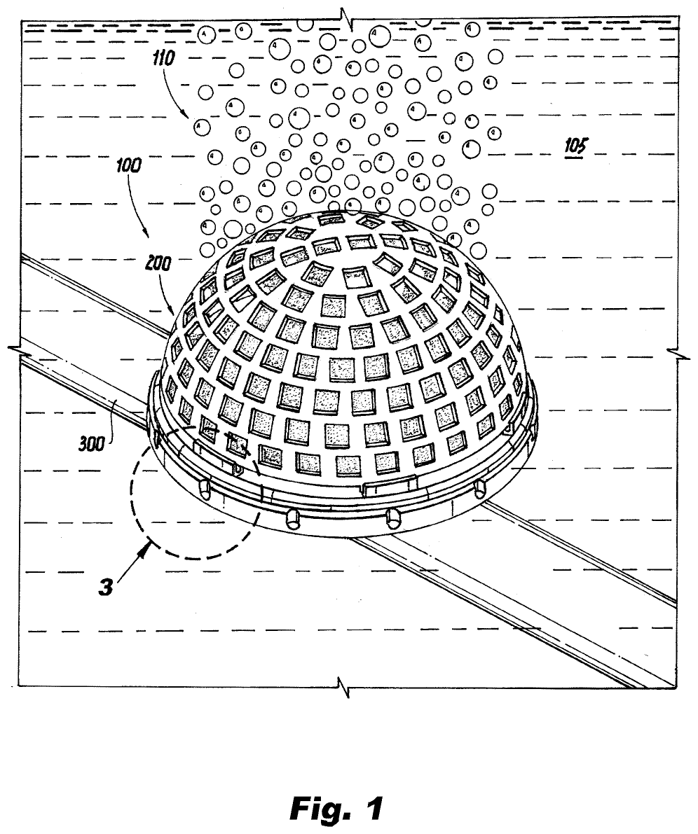

FIG. 1 shows a perspective view of an aeration system 100 in accordance with an illustrative embodiment of the invention. In this example, the aeration system 100 is immersed in wastewater 105 in a wastewater treatment tank. The aeration system 100 comprises a diffuser 200 that is attached to an air distribution pipe 300. The air distribution pipe 300 delivers pressurized air to the diffuser 200, causing the diffuser 200 to release a plume of bubbles 110 into the wastewater 105. The plume of bubbles 110 supports beneficial aerobic biological processes in the wastewater 105.

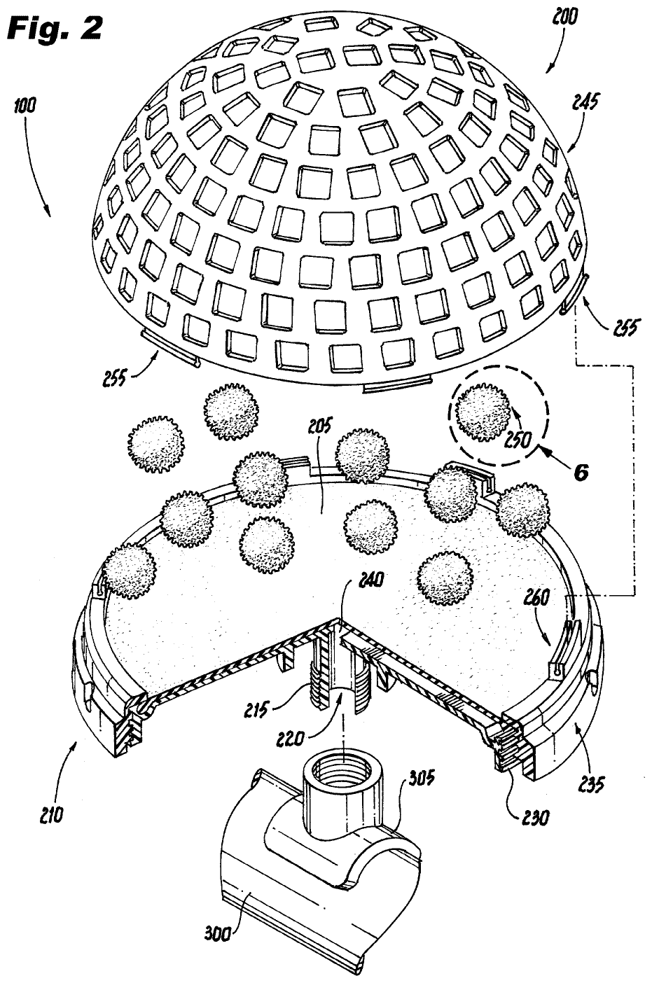

FIGS. 2-6 show additional aspects of the aeration system 100 and the way it operates. FIG. 2 shows an exploded partially broken perspective view of the diffuser 200 and the associated air distribution pipe 300. The diffuser 200 is a disc diffuser and comprises a flexible diffuser membrane 205, which sits atop a diffuser body 210. The flexible diffuser membrane 205 is densely perforated except in a small circular region near its center, which is purposefully devoid of perforations. The diffuser body 210 comprises a threaded connector 215, an air inlet 220, a receiving surface 230, and a retainer ring 235. The retainer ring 235 is disposed along a circumference of the diffuser body 210. The receiving surface 230 and the retainer ring 235 threadably engage to capture the flexible diffuser membrane 205 against the diffuser body 210. The air inlet 220 narrows near its top, creating an orifice 240 immediately below the flexible diffuser membrane 205.

A threaded grommet 305 penetrates the air distribution pipe 300 and is attached to the air distribution pipe 300 by an adhesive. The diffuser 200 is mounted on the air distribution pipe 300 by having the threaded connector 215 engage the threaded grommet 305. The diffuser 200 is thereby placed into gaseous communication with the interior of the air distribution pipe 300.

The top portion of the diffuser 200 includes a cage 245 and cleaning elements 250. In the exemplary diffuser 200, the cage 245 is dome shaped. Several cleaning elements 250 are enclosed by the cage 245. So arranged, the cleaning elements 250 are trapped between the flexible diffuser membrane 205 and the cage 245. The cleaning elements 250 are thereby positioned where they will be agitated by the plume of bubbles 110 released from the flexible diffuser membrane 205.

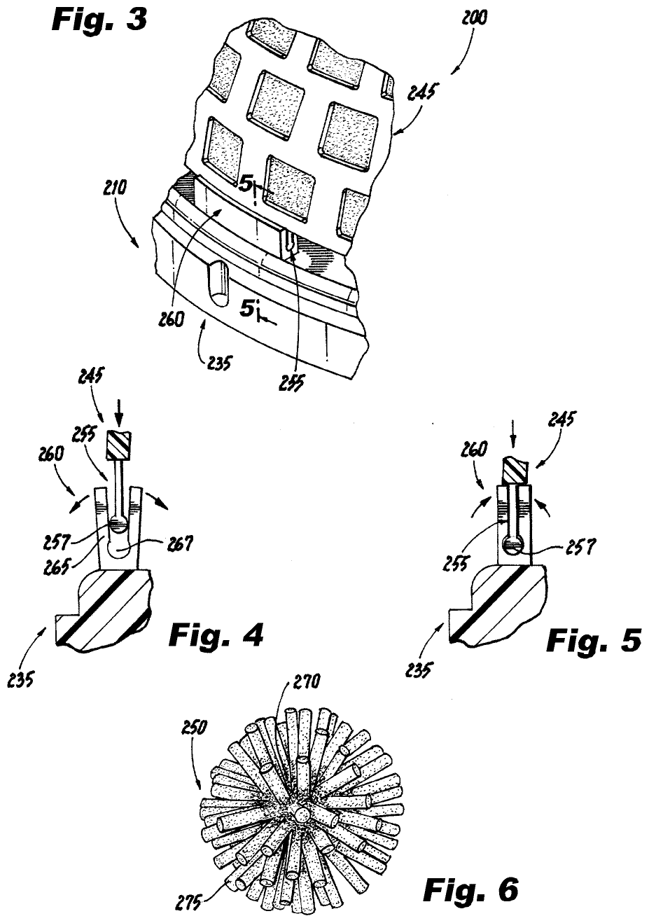

The cage 245 is attached to the diffuser body 210 via snap-fit attachment. FIGS. 3-5 provide details of this attachment. FIG. 3 shows a magnified perspective view of the diffuser 200 in the region indicated in FIG. 1, while FIGS. 4 and 5 show sectional views along the cleave plane indicated in FIG. 3 during and after snap-fit attachment. A bottom edge of the cage 245 defines several tabs 255, each comprising an enlarged cylindrical region 257 at its terminus. The retainer ring 235, in turn, defines a series of clips 260, each formed of a pair of opposing walls 265 that mutually define a notch 267 near their bottoms. Pressing the tabs 255 into the clips 260 causes the opposing walls 265 of the clips 260 to at first spread apart (FIG. 4), and then to relax once the enlarged cylindrical regions 257 of the tabs 255 occupy the notches 267 in the clips 260 (FIG. 5). Once seated in this manner, the cage 245 is securely attached directly to the retainer ring 235.

FIG. 6 shows a side view of a representative one of the cleaning elements 250. In this embodiment, the cleaning element 250 comprises a central ball 270 with a plurality of arms 275 projecting therefrom.

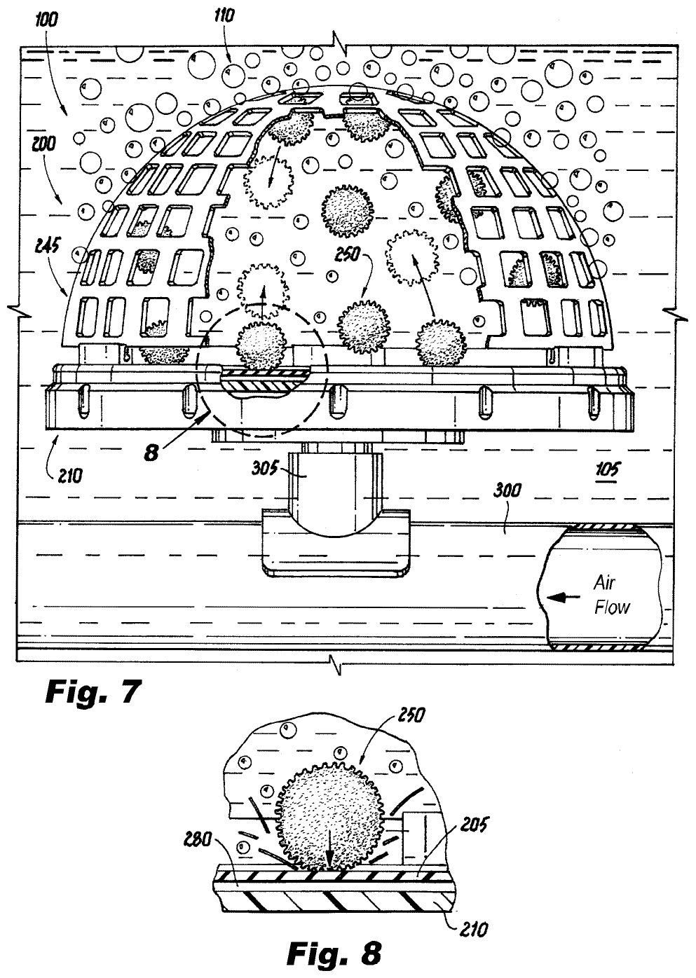

FIGS. 7 and 8 further describe how the diffuser 200 operates. FIG. 7 shows a partially broken side view of the diffuser 200, and FIG. 8 shows a magnified side view of the region indicated in FIG. 7. When pressurized air is provided to the diffuser 200 via the air distribution pipe 300, the air enters the air inlet 220 and fills a space 280 between the flexible diffuser membrane 205 and the underlying diffuser body 210. This expands the flexible diffuser membrane 205 away from the diffuser body 210, causing the perforations in the flexible diffuser membrane 205 to open so that the air discharges through the perforations in the form of fine bubbles (i.e., the plume of bubbles 110). When the air pressure is relieved, the flexible diffuser membrane 205 again relaxes against the diffuser body 210 so that the unperforated central region of the flexible diffuser membrane 205 overlies the air inlet 220. This prevents the wastewater from the wastewater treatment tank from entering the diffuser 200 in the opposite direction.

The plume of bubbles 110 released by the flexible diffuser membrane 205 agitates the cleaning elements 250 residing above the flexible diffuser membrane 205. As a result of this agitation, the cleaning elements 250 repeatedly impact against the flexible diffuser membrane 205, effectively cleaning the flexible diffuser membrane 205 by a scrubbing or scouring action. The arms 275 of the cleaning elements 250 essentially act as bristles during the cleaning process. The agitated cleaning elements 250 also impact the cage 245 and thereby clean the cage 245 as well. The repeated impacts clean the flexible diffuser membrane 205 of fats, greases, calcium, calcium compounds, and other organic and inorganic substances that may stick to the flexible diffuser membrane 205 while in deployed.

In this manner, cleaning of the diffuser 200 occurs continuously and in situ while the diffuser 200 is in operation. This continuous, in situ cleaning lessens the deleterious effects of contaminants that commonly stick to diffusers in wastewater applications. A lower flow resistance, a smaller bubble size, and a more spatially uniform bubble pattern are thereby maintained for a longer period than would be experienced with a conventional diffuser in like conditions. Aeration efficiency and the interval between expensive and disruptive maintenance are increased when compared to prior designs.

At the same time, the snap-fit attachment between the cage 245 and the diffuser body 210 allows this attachment to be quickly performed in the field without specialized training and without specialized tooling. The resultant attachment is solid and robust, but can be reversed if desired when, for example, maintaining the diffuser 200. That is the cage 245 can be released from the diffuser body 210 by simply prying the opposing walls 265 of the clips 260 apart to release the tabs 255.

Aspects of the invention thereby describe the diffuser 200 comprising the diffuser body 210, the flexible diffuser membrane 205, the cage 245, and the cleaning element 250. The flexible diffuser membrane 205 and the cage 245 are attached to the diffuser body 210. The cleaning element 250 is trapped between the flexible diffuser membrane 205 and the cage 245. In use, providing pressurized air to the diffuser 200 with the diffuser 200 immersed in the wastewater 105 causes the flexible diffuser membrane 205 to release the plume of bubbles 110 into the wastewater 105. The plume of bubbles 110 agitates the cleaning element 250 causing repeated impacts between the cleaning element 250 and the flexible diffuser membrane 205.

Once understood from the teachings provided herein, the elements of the diffuser 200 may be sourced commercially or fabricated from conventional materials utilizing conventional fabrication techniques. These materials and fabrication techniques will be familiar to one having ordinary skill in the fabrication arts. The diffuser body 210, the retainer ring 235, and the cage 245 may, for example, be made from a plastic or a metal. Suitable plastics include polypropylene, acrylonitrile butadiene styrene, polyvinyl chloride, and polyoxymethylene, while suitable metals include stainless steel. These parts may be molded or cast. The flexible diffuser membrane 205 may also be made utilizing several different materials including, but not limited to, ethylene-propylene-diene-monomer rubber, polyurethane rubber, silicone rubber, and nitrile butadiene rubber. Compression molding is presently the preferred manufacturing technique for flexible diffuser membranes, although other manufacturing techniques would also come within the scope of the invention. Once released from a mold, the flexible diffuser membrane 205 is preferably perforated with needles or knives, as desired.

The cleaning elements 250 may comprise, for example, a plastic such as polymethyl methacrylate, polycarbonate, polyethylene, polypropylene, polyethylene terephthalate, polyvinyl chloride, acrylonitrile-butadiene-styrene, and the like; or a rubber such as natural rubber, styrene butadiene rubber, polybutadiene rubber, ethylene propylene diene monomer, nitrile rubber, neoprene rubber, silicone rubber, and the like. A combination of materials may also be utilized. Formation of the cleaning elements 250 may be by, for example, conventional injection molding or extrusion. Specific gravities allowing the cleaning elements 250 to repeatedly strike the flexible diffuser membrane 205 and the cage 245 when agitated by the plume of bubbles 110 is preferred to encourage the cleaning action described above. The specific gravities of the cleaning elements 250 may be equal to, less than, or greater than one, depending on the behavior of the cleaning elements 250 when agitated by the plume of bubbles 110. The specific gravities may, for example, fall within the range of 0.9 to 3.0, although this range is provided by way of example and is not intended to be limiting.

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

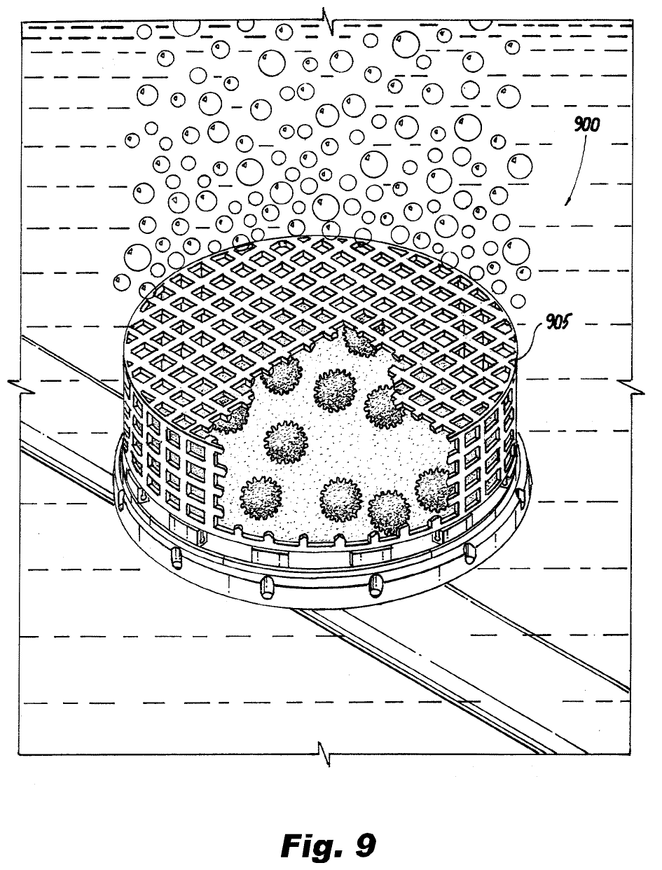

Alternative embodiments may, for example, utilize cages having a different shape from the cage 245 in the diffuser 200. FIG. 9 shows a partially broken perspective view of a first alternative diffuser 900. The first alternative diffuser 900 includes a first alternative cage 905 that defines a flat top. Any number of alternative cage shapes are also contemplated and would fall within the scope of the invention.

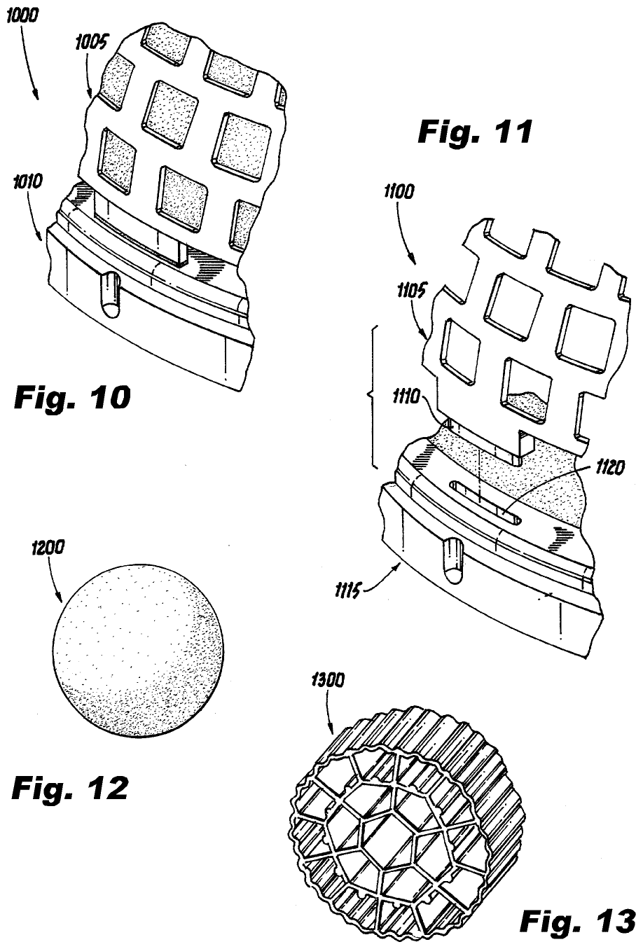

Moreover, while attachment between the cage and the retainer ring 235 in the diffuser 200 is via a snap-fit attachment, a myriad of other forms of attachment would also fall within the scope of the invention. FIG. 10 shows a magnified perspective view of a portion of a second alternative diffuser 1000 similar to the diffuser 200, but wherein a second alternative cage 1005 is integral to a second alternative retainer ring 1010. In such an embodiment, the second alternative cage 1005 and the second alternative retainer ring 1010 may be manufactured as a single element, or they may be joined together at some point during manufacture (e.g., by adhesive bonding, welding, or the like). FIG. 11 shows an exploded magnified perspective view of a portion of a third alternative diffuser 1100, again similar to the diffuser 200, but wherein a third alternative cage 1105 defines inserts 1110 and a third alternative retainer ring 1115 defines slots 1120. The third alternative cage 1105 may be joined (e.g., by adhesive bonding, welding, or the like) to the third alternative retainer ring 1115 with the inserts 1110 inserted into the slots 1120. Engagement of the inserts 1110 and the corresponding slots 1120 provides precise alignment between the third alternative cage 1105 and the third alternative retainer ring 1115 and adds strength to the resultant combination once joined.

Alternative embodiments may also use different means of attachment between the diffuser and the air distribution pipe from that expressly described above. Alternative means of attachment include, as just two examples, press-fit attachment and use of saddles.

Finally, cleaning elements may take on forms different from the cleaning element 250 in the diffuser 200 and still fall within the scope of the invention. A cleaning element may take the form of a sphere, a cylinder, a cone, a torus, a polyhedron, or any other suitable shape. They may be solid, hollow, or in the form of a foam. They may be coarse or smooth, and they may be formed of plastic, rubber, or any other suitable material. Specific gravities may vary as required to achieve the desired cleaning dynamic. Lastly, combinations of different designs may be utilized simultaneously in a single diffuser. By way of example, FIG. 12 shows a perspective view of a first alternative cleaning element 1200 in the form of a rubber ball. FIG. 13 shows a perspective view of a second alternative cleaning element 1300 in the form of a plastic moving bed biofilm reactor (MBBR) medium. MBBR media may be a convenient source of cleaning elements since this kind of media may already be available at wastewater treatment sites.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. A diffuser comprising:
a diffuser body;
a flexible diffuser membrane attached to the diffuser body;
a cage attached to the diffuser body; and
a cleaning element trapped between the flexible diffuser membrane and the cage.

2. The diffuser of claim 1, wherein the diffuser is a disc diffuser.

3. The diffuser of claim 2, wherein the diffuser body comprises:
a receiving surface; and
a retainer ring forming a circumference of the diffuser body and threadably engaging the receiving surface to capture the flexible diffuser membrane against the diffuser body.

4. The diffuser of claim 3, wherein the cage is directly attached to the retainer ring.

5. The diffuser of claim 4, wherein the cage is attached to the retainer ring by snap-fit attachment.

6. The diffuser of claim 4, wherein:
the cage defines an insert; and
the retainer ring defines a slot engaged by the insert.

7. The diffuser of claim 4, wherein the cage is integral to the retainer ring.

8. The diffuser of claim 7, wherein the cage is joined to the retainer ring by an adhesive or by welding.

9. The diffuser of claim 1, wherein the cage is shaped like a dome.

10. The diffuser of claim 1, wherein the cage defines a flat top.

11. The diffuser of claim 1, wherein the diffuser comprises a plurality of cleaning elements trapped between the flexible diffuser membrane and the cage.

12. The diffuser of claim 1, wherein the cleaning element defines a sphere, a cylinder, a cone, a torus, or a polyhedron.

13. The diffuser of claim 1, wherein the cleaning element is made of plastic or rubber.

14. The diffuser of claim 1, wherein the cleaning element comprises a central ball with a plurality of arms projecting therefrom.

15. The diffuser of claim 1, wherein the cleaning element comprises a moving bed biofilm reactor medium.

16. The diffuser of claim 1, wherein:
providing pressurized air to the diffuser with the diffuser immersed in wastewater causes the flexible diffuser membrane to release a plume of bubbles into the wastewater;
the plume of bubbles agitates the cleaning element causing repeated impacts between the cleaning element and the flexible diffuser membrane; and
the repeated impacts between the cleaning element and the flexible diffuser membrane clean the flexible diffuser membrane.

17. The diffuser of claim 16, wherein:
the plume of bubbles agitates the cleaning element further causing repeated impacts between the cleaning element and the cage; and
the repeated impacts between the cleaning element and the cage clean the cage.

18. A system comprising:
an air distribution pipe; and
a diffuser attached to the air distribution pipe and in gaseous communication with an interior of the air distribution pipe, the diffuser comprising:
a diffuser body;
a flexible diffuser membrane attached to the diffuser body;
a cage attached to the diffuser body; and
a cleaning element trapped between the flexible diffuser membrane and the cage;
wherein:
the diffuser is immersed in wastewater;
providing pressurized air to the diffuser causes the flexible diffuser membrane to release a plume of bubbles into the wastewater;
the plume of bubbles agitates the cleaning element causing repeated impacts between the cleaning element and the flexible diffuser membrane; and
the repeated impacts between the cleaning element and the flexible diffuser membrane clean the flexible diffuser membrane.

19. The system of claim 18, wherein the plume of bubbles aerates the wastewater.
